(19) United States
(12) Patent Application Publication
(10) Pub. No.: US 2008/0102025 A1
(43) Pub. Date: May 1, 2008

(54) Hydrothermal Synthesis In Pressure Vessels

(76) Inventors: Volker Kurth, Bad Aibling (DE); Attila Jambor, Prien (DE); Richard Rau, Kleinhohenrain (DE); Christian Ringelhan, Rosenheim (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(21) Appl. No.: 11/576,952

(22) PCT Filed: Oct. 13, 2005
(86) PCT No.: PCT/EP05/11033

§ 371 Date: Sep. 19, 2007

(30) Foreign Application Priority Data
Oct. 13, 2004 (DE) 10 2004 049 914.4

(51) Int. Cl. C01B 39/04

(52) U.S. Cl. 423/702

(57) ABSTRACT

The invention relates to a reaction vessel comprising at least:

a pressure-resistant main tank (1);

a turbulence-reduction tank (2) connected to the main tank (1);

wherein the turbulence-reduction tank (2) has a pressure-regulating valve (9) through which gaseous products can be discharged from the turbulence-reduction tank (2) to the outside. The invention further relates to a process for producing molecular sieves, in particular zeolites, which can be carried out in the reaction vessel of the invention.

The present invention relates to a reaction vessel and a process for producing a molecular sieve.

Molecular sieves are usually produced by heating a synthesis gel comprising suitable starting materials, in the synthesis of zeolites for example an aluminum source and a silicon source, in predominantly aqueous solution under hydrothermal conditions for a number of days. The reaction is usually carried out in the presence of an organic template, for example a quaternary ammonium salt. However, at the temperatures employed during the synthesis, some of these quaternary ammonium compounds, e.g. tetraethylammonium hydroxide, tend to undergo Hofmann elimination to form gaseous decomposition products such as amines or low molecular weight hydrocarbons. These gaseous by-products collect in the gas space of the reaction vessel and there lead to a pressure increase which can be controlled only with difficulty. To prevent the maximum permissible pressure of the vessel from being exceeded as a result of evolution of gaseous by-products, the reaction can be carried out under conditions under which the Hofmann elimination is suppressed. For this purpose, it is possible, for example, to carry out the reaction at lower temperatures or reduce the basicity of the synthesis gel. However, this firstly increases the synthesis times and secondly reduces the phase purity of the molecular sieve formed. Both are undesirable.

WO 03/043937 A2 proposes carrying out the production of zeolites at temperatures above 125° C. using a mixture of quaternary ammonium halides and quaternary ammonium hydroxides as templates. The ratio of halides to hydroxide is selected so that, as a result of the reduced basicity of the synthesis gel, the pressure in the reaction vessel at the end of the reaction is significantly lower than when using pure ammonium hydroxides, without the reaction temperature having to be reduced significantly for this purpose.

A further possible way of enabling the reaction to be carried out at high temperatures is to increase the pressure resistance of the reaction vessel appropriately. However, this results in a significant increase in the capital costs.

The uncontrolled increase in the pressure in the reaction vessel as a result of gaseous by-products formed in the reaction also occurs in other syntheses. Here too, the vessels have to be designed for the pressure peaks to be expected or the reaction conditions have to be modified appropriately in order to be able to carry out the reaction using a given reaction vessel having a particular pressure resistance.

A first object of the invention was therefore to provide a reaction vessel in which reactions in which gaseous by-products are formed can be carried out without danger and with the capital costs for the reaction vessel being kept low.

This object is achieved by a reaction vessel having the features of claim 1. Advantageous embodiments are subject matter of the dependent claims.

The reaction vessel of the invention comprises two different tanks which are connected to one another. Both tanks have a particular pressure resistance, so that a reaction can be carried out at elevated pressure. A main tank which generally has larger dimensions is initially charged with the reaction mixture. In terms of its structure, this main tank corresponds essentially to known pressure vessels for carrying out chemical reactions. The tank is made of a suitable material which is stable to the components of the reaction mixture under the reaction conditions. An example of a suitable material is stainless steel. The main tank can be provided with a heating device, for example a heating coil or a heating jacket, so that the interior of the main tank can be heated to a particular temperature by means of a suitable heat transfer medium, for example steam or oil. The tank can also have customary closable openings through which the components of the reaction mixture can be introduced into the interior of the main tank. The main tank can be provided with a stirrer and with customary feed lines and discharge lines in order, for example, to charge the tank with liquids or flush it with an inert gas.

The main tank is connected to a turbulence-reduction tank. The turbulence-reduction tank generally has smaller dimensions than the main tank. The turbulence-reduction tank likewise has a particular pressure resistance, so that the same pressure can be set in the main tank and in the turbulence-reduction tank. The turbulence-reduction tank is likewise made of a material which is inert toward the components of the reaction mixture under the reaction conditions, for example stainless steel.

The turbulence-reduction tank has a pressure-limiting valve through which gaseous products can be discharged from the turbulence-reduction tank to the outside. The pressure-limiting valve opens at a particular pressure so that the gaseous products can be discharged from the reaction vessel and the pressure in the reaction vessel drops. When the pressure in the reaction vessel has dropped to a particular value, the pressure-limiting valve closes again. In this way, a reaction in which gaseous by-products are formed can be carried out over a longer period, for example a number of days, in a reaction vessel which has a pressure resistance which is significantly lower than the pressure resistance of a reaction vessel in which the gaseous by-products remain for the duration of the reaction and therefore contribute to a significantly higher pressure in the interior of the vessel. The reaction vessel can thus be designed for lower pressures, which significantly reduces the capital costs.

In the main tank, the reaction mixture is heated to boiling, for example while stirring. The components which have gone into the gas space can then go over into the turbulence-reduction tank. In the turbulence-reduction tank, there is significantly lower turbulence of the gas phase than in the main tank. As a result, entrained liquid can settle and flow back into the main tank. The gas phase can be then be discharged via the pressure-limiting valve until the desired pressure is attained. The discharged gases can, if appropriate after a cooling phase, be let out into the atmosphere or worked up in accordance with legal requirements.

The pressure-limiting valve is preferably configured as a spring valve. The maximum pressure prevailing the reaction vessel can be set by means of the spring constant or the counterforce exerted by the spring. When the pressure in the reaction vessel exceeds the predetermined value, the pressure-limiting valve is opened against the spring force of the spring valve, so that gaseous materials can escape from the reaction vessel and the pressure drops. When a particular pressure has been reached, the spring valve is closed again by the force exerted by the spring. Spring valves can be produced comparatively cheaply. Designs in which the spring force can be adjusted so that the reaction vessel can also be used for different reactions are also available.

However, apart from the spring valve, it is also possible to use other types of pressure-limiting valves. For example, a magnetically or electrically switching valve controlled via pressure sensors which measure the internal pressure in the reaction vessel can also be used. Suitable valves are in principle all valves which open at a particular, predetermined pressure so that the pressure in the reaction vessel decreases and close again after the pressure has dropped to a predetermined value. All valves which open and close reversibly are suitable.

The turbulence-reduction tank serves first and foremost to reduce the turbulence of the vapor rising from the main tank. As indicated above, no or very little turbulence should, if possible, occur in the gas phase of the turbulence-reduction vessel, so that liquid or condensed material settles and flows back into the main tank. The turbulence-reduction tank can therefore have a volume which is significantly smaller than the volume of the main tank. The volume of the turbulence-reduction tank is preferably from 0.5% to 5% of the volume of the main tank. However, the dimensions of the main tank and the turbulence-reduction tank also depend on the reactions carried out and can therefore also be outside the range indicated. For economic reasons, the turbulence-reduction tank is made as small as possible.

Main tank and turbulence-reduction tank are connected by a line, with the cross section of the line being selected so that liquid material such as condensate can flow back from the turbulence-reduction tank into the main tank without backpressure. If the cross section of the line is made too small, the liquid phase accumulates in the turbulence-reduction tank so that effective separation of gaseous and liquid phases can no longer take place in this and liquid is also discharged from the reaction vessel via the pressure-regulating valve. The cross section of the line depends on the dimensions of the main tank or the turbulence-reduction tank and also on the reaction conditions. However, the dimensions of the cross section of the line can easily be determined by a person skilled in the art on the basis of the flows to be expected.

The cross section of the line is preferably less than 10% of the cross section of the turbulence-reduction tank, preferably less than 5%, particularly preferably less than 3%.

The turbulence-reduction tank is preferably arranged above the main tank, with the line between turbulence-reduction tank and main tank preferably running essentially vertically.

The turbulence-reduction tank is preferably cooled in order to condense gaseous components of the reaction mixtures. Cooling can be effected, for example, by means of water. However, cooling is preferably effected by means of air. This can flow along the exterior wall of the turbulence-reduction tank in order to carry away the heat. The undesirable gaseous by-products often have a significantly lower condensation point than the reactants or products, so that efficient removal of the by-products is also possible by means of simple air cooling. The dimensions of the turbulence-reduction tank are preferably selected so that, apart from the undesirable gaseous by-products, only small proportions of the constituents of the reaction mixture are discharged from the reaction vessel. The maximum heat to be removed can therefore be set via the size of the turbulence-reduction tank. The ratio of height to width of the turbulence-reduction tank is preferably in the range from 3/1 to 1/5.

The reaction vessel of the invention is suitable for carrying out reactions under superatmospheric pressure. It therefore has an increased pressure resistance. Main tank and turbulence-reduction tank preferably have a pressure resistance of at least 10 bar, preferably from 10 to 15 bar. The range of fluctuation of the pressure-regulating valve is preferably set to less than 2 bar, preferably less than 1 bar. In this way, the reactions can be carried out under approximately isobaric conditions.

As indicated above, gaseous by-products which can lead to a large pressure increase in the reaction vessel are formed from the template compounds present in the reaction mixture in the synthesis of molecular sieves, in particular zeolites. The reaction vessel of the invention is particularly suitable for the synthesis of zeolites. The use of the reaction vessel of the invention makes it possible to discharge the gaseous by-products from the reaction vessel while carrying out the reaction and thus to avoid a large pressure increase in the reaction vessel.

The invention therefore also provides a process for producing a molecular sieve, wherein:

a synthesis gel comprising:
a) at least one starting material selected from the group consisting of an aluminum source, a silicon source, a titanium source, a gallium source, a chromium source, a boron source, an iron source, a germanium source and a phosphorus source;
b) an organic template;
c) if appropriate, an alkali metal and/or alkaline earth metal ion source M having a valence n;
   in predominantly aqueous solution is produced;
   the synthesis gel is crystallized under essentially isobaric conditions in a reaction vessel as described above;
   the solid is separated off, and
   the solid is, if appropriate, washed and dried.

As aluminum source, it is in principle possible to use all customary aluminum sources with which those skilled in the art are familiar. Suitable sources are, for example, activated aluminum oxide, γ-aluminum oxide, aluminum hydroxide, sodium aluminate, aluminum nitrate and aluminum sulfate. If alkali metal ions are introduced into the synthesis, sodium aluminate is particularly preferred.

As silicon source, it is likewise possible to use customary silicon sources. Preference is given to using precipitated silica as silicon source.

As titanium source, gallium source, chromium source, boron source, iron source, germanium source and phosphorus source, it is likewise possible to use all customary starting materials with which those skilled in the art are familiar.

A suitable titanium source is, for example, titanium oxide, tetraethyl orthotitanate, tetrapropyl orthotitanate, titanium chloride.

A suitable gallium source is, for example, gallium nitrate.

A suitable chromium source is, for example, chromium oxide, chromium nitrate, chromium chloride, chromium acetylacetonate.

A suitable boron source is, for example, boric acid.

A suitable iron source is, for example, iron nitrate, iron sulfate, iron acetylacetonate.

A suitable germanium source is, for example, germanium oxide, germanium chloride.

A suitable phosphorus source is, for example, phosphoric acid.

The abovementioned starting materials can be used either individually or preferably in a mixture of at least two components. To more than two components are used, one of the components is usually added in a significantly lower proportion than the other two components. The proportion of the third or further components is preferably from 0.1 to 20% by weight, preferably from 1 to 10 mol %, based on the totality of the sources used as starting material.

Particular preference is given to producing zeolites by the process of the invention. These are produced from a silicon source and an aluminum source, with proportions of the other abovementioned sources being able to be added if appropriate.

To form the desired structure, suitable organic templates are added to the synthesis gel. Suitable classes of templates are, for example, amines, quaternary ammonium salts, alcohols, ketones, phosphonium salts.

In the production of, for example, zeolites, preference is given to using quaternary ammonium salts which tend to decompose into by-products at elevated temperatures, for example tetraalkylammonium hydroxides, where the alkyl groups preferably have from two to eight carbon atoms, as templates. Here, tetraethylammonium hydroxide is particularly preferred.

As alkali metal and/or alkaline earth metal ion source, it is possible to use all customary compounds which contain an alkali metal or alkaline earth metal ion M having a valence n and with which those skilled in the art are familiar. The valence n is 1 for alkali metals and 2 for alkaline earth metals. Particular preference is given to using sodium as alkali metal. As alkali metal source, particular preference is given to using alkali metal hydroxides, preferably sodium hydroxide.

In the synthesis of a molecular sieve, a mixture, preferably a solution, of the starting materials, the organic template and, if appropriate, the alkali metal and/or alkaline earth metal ion source is preferably firstly prepared in the reaction vessel. As solvent, use is made of water which may also contain relatively small proportions of organic solvents, for example alcohols such as methanol, ethanol or isopropanol, dimethylformamide or dimethyl sulfoxide, with the proportion preferably being less than 10% by weight, particularly preferably less than 5% by weight, in particular less than 1% by weight, in each case based on the weight of the solvent, i.e. the water and the organic solvent which may be present.

The order in which the individual components of the synthesis gel are dissolved in the solvent is in principle not subject to any restrictions. It is possible firstly to dissolve the organic template in water and subsequently dissolve the further components therein, or else to prepare a solution of the starting materials first and then dissolve the organic template therein. In principle, it is possible to employ the same procedure as is known for producing the respective molecular sieves.

The synthesis gel is then heated under hydrothermal conditions, with the pressure in the reaction vessel being kept below a pre-determined maximum pressure by use of the above-described reaction vessel and gaseous by-products being able to escape from the reaction vessel. The reaction time is selected as a function of the molecular sieve synthesized and is also dependent on the amount of synthesis gel reacted. Here, recourse can be made, as one alternative, to values which are based on experience and are available from the synthesis in known reaction vessels. As another alternative, a person skilled in the art can determine the required reaction time by means of trials or by sampling during the reaction.

As indicated above, the process of the invention is particularly useful for the production of zeolites.

In the synthesis of a zeolite, a solution of tetraethylammonium hydroxide or another suitable tetraalkylammonium salt in demineralized water is preferably firstly provided. The aluminum source, for example sodium aluminate, and, if appropriate, a source of alkali metal and/or alkaline earth metal ions M having the valence n, for example sodium hydroxide, are subsequently added to this solution and the mixture is stirred until a solution of the constituents is obtained. The silicon source, for example, precipitated silica, is subsequently added to this solution a little at a time to give a highly viscous gel. The synthesis of the zeolite is preferably carried out in a small amount of water as solvent. For this purpose, the molar ratio of H₂0:SiO₂ is preferably set in the range from 5 to 15. The reaction vessel is then closed and the pressure-regulating valve of the turbulence-reduction tank is set to a particular value. The main tank is heated so that the pressure in the interior of the tank rises. The pressure-regulating valve is preferably set so that the reaction proceeds at the given temperature under hydrothermal conditions and only the increase in pressure due to evolution of gaseous by-products leads to opening of the pressure-regulating valve. The pressure-regulating valve is preferably set so that the reaction is carried out at a pressure of more than 8 bar, preferably at a pressure in the range from 10 to 13 bar. For this purpose, the temperature in the main tank is preferably set to temperatures in the range from 120° C. to 200° C., in particular from 140° C. to 180° C., for crystallization of the synthesis gel. The crystallization is particularly usefully carried out at a temperature of about 160° C. The crystallization time is preferably from about 50 to 500 hours, in particular from about 100 to 250 hours. The crystallization time is influenced, for example, by the crystallization temperature. These synthesis conditions give a solid which corresponds in terms of its purity, crystallinity and crystal size to a solid as is obtained using an identical synthesis gel at a higher synthesis pressure without use of the reaction vessel of the invention. The solid preferably has primary crystallites having a mean primary crystallite size of not more than about 0.1 μm.

The crystallized product is subsequently separated off from the mother liquor. For this purpose, the reaction mixture can, for example, be filtered by means of a membrane filter press. However, other methods of separating off the solid can likewise be employed. The solid can also be separated off by, for example, centrifugation. The solid which has been separated off is subsequently washed with demineralized water. Washing is preferably continued until the electrical conductivity of the washings has dropped below 100 μs/cm.

The precipitate which has been separated off can subsequently be dried. Drying is, for example, carried out in air in customary drying apparatuses. The drying temperature is, for example, selected in the range from 100° C. to 120° C. The drying time is generally in the range from about 10 to 20 hours. The drying time is dependent on the moisture content of the solid which has been separated off and on the size of the batch. The dried solid can subsequently be comminuted in a customary way, in particular granulated or milled.

To remove the template, the solid can be calcined. The calcination is carried out in the presence of air, with temperatures in the range from 400 to 700° C., preferably from 500 to 600° C., being selected. The calcination time is generally from 3 to 12 hours, preferably from 3 to 6 hours. The times indicated for the calcination are based on the time for which the zeolite is maintained at the maximum temperature. Heating and cooling times are not taken into account. The amount of exchangeable cations, in particular alkali metal ions, present in the catalyst can, for example, be influenced by treatment with suitable cation sources such as ammonium ions, metal ions, oxonium ions or mixtures thereof, with the exchangeable ions present in the zeolite, in particular alkali metal ions, being replaced. The catalyst laden with the appropriate ions can subsequently be washed and dried again. Drying is carried out, for example, at temperatures of from 110 to 130° C. for a time of from 12 to 16 hours. To convert the catalyst into an acid-activated form in the case of a replacement using ammonium ions, the catalyst can be additionally calcined, for example at temperatures in the range from 460 to 500° C. for a time of from 6 to 10 hours. Finally, the catalyst can be additionally milled.

The reaction conditions have been described by way of example for the production of a zeolite. To produce other molecular sieves, it is in principle possible to use the same reaction conditions. Thus, for example, aluminum phosphates can be produced under analogous conditions.

The molecular sieve obtained or preferably the zeolite obtained can be used in powder form. However, to increase the mechanical stability and to aid handling, the molecular sieve or the zeolite can also be processed to produce shaped bodies. For this purpose, the molecular sieve or the zeolite can, for example, be pressed with or without addition of binders to form appropriate shaped bodies. However, shaping can also be effected by other methods, for example by extrusion. Here, the powder obtained is admixed with a binder, for example pseudoboehmite, and shaped to produce shaped bodies. The shaped bodies can subsequently be dried, for example at temperatures of from 100 to 130° C. If appropriate, the shaped bodies can be additionally calcined, generally at temperatures in the range from 400 to 600° C.

The process of the invention is particularly suitable for producing ZSM-12 zeolites. In this case, a tetraethylammonium salt, preferably the hydroxide, is used as template. In particular, the process of the invention is suitable for producing a ZSM-12 zeolite as is described in DE 103 14 753.

The synthesis of the zeolite is preferably carried out directly with the desired SiO₂/Al₂0₃ ratio by setting the amount of silicon source and aluminum source in the synthesis gel composition appropriately. The SiO₂/Al₂0₃ ratio in the synthesis gel composition is approximately the same as the SiO₂/Al₂0₃ ratio in the ZSM-12 zeolite. The proportion of SiO₂ in the synthesis gel composition generally differs, as a person skilled in the art will know, by about ±10% from the proportion in the finished zeolite. Only at very high or very low proportions of SiO₂ are larger deviations observed. As a result, no subsequent dealumination of the zeolite in order to set the SiO₂/Al₂0₃ ratio is necessary. The aluminum content of the zeolite of the ZSM-12 type therefore does not subsequently have to be reduced by addition of acid and leaching out of aluminum atoms. It is assumed that the direct synthesis makes a homogeneous buildup of the zeolite possible and avoids “extra-framework” aluminum which is formed in subsequent dealumination after the zeolite synthesis and can have an adverse effect on the activity or selectivity of the ZSM-12 zeolite.

The molar ratio of TEA⁺/SiO₂ set in the synthesis gel is preferably low. A molar ratio of TEA⁺/SiO₂ in the range from about 0.10 to 0.18 is preferably selected. The molar ratio of SiO₂/Al₂0₃ in the synthesis gel composition is preferably set to a value in the range from about 50 to about 150.

The synthesis gel should preferably also have a comparatively low alkali metal and/or alkaline earth metal content, with the molar ratio of M_{2/n}O:SiO₂ advantageously being able to be from about 0.01 to 0.045. Here, M_{2/n}O is the oxide of the alkali or alkaline earth metal having the valence n. Furthermore, a comparatively low molar ratio of H₂0:SiO₂ of from about 5 to 18, preferably from 5 to 13, in the synthesis gel is advantageously used. The metal ion M is preferably an alkali metal, particularly preferably sodium.

The silicon source has a considerable influence on the morphology and catalytic activity of the ZSM-12 zeolite produced. Preference is given to using a precipitated silica which has a lower reactivity than colloidal silica. In this way, an influence can be exerted over the mean size of the primary crystallites obtained, which should preferably be less than 0.1 μm. The precipitated silica preferably has a BET surface area of ≦200 m²/g.

The mean size of the primary crystallites in the ZSM-12 zeolite produced is comparatively low and is less than 0.1 μm. The primary crystallite size can be determined from scanning electron micrographs by measuring the length and width of a number of primary crystallites. The arithmetic mean of the primary crystallite sizes measured is then formed. There is generally no significant difference between the width and length of the primary crystallites obtained. Should such a difference occur in a particular case, the largest diameter and the smallest diameter of the crystallite is determined to determine the primary crystallite size.

Specifically, scanning electron micrographs of the washed and dried but uncalcined, template-containing ZSM-12 zeolite at a magnification of from 68 000 to 97 676 are prepared (instrument: Leo 1530; Leo GmbH, Oberkochen, Del.). 30 primary crystallites which are clearly delineated are selected in the micrographs and their length and width is measured and the mean is determined therefrom. The arithmetic mean of the diameters determined in this way, i.e. the mean primary crystallite size, is then formed. The primary crystallite size is not significantly influenced by calcination. The primary crystallite size can therefore be determined either directly after the synthesis of the zeolite of the ZSM-12 type or after calcination.

The primary crystallites preferably have a size in the range from about 10 to 80 nm, particularly preferably in the range from about 20 to 60 nm. The catalyst thus comprises comparatively small primary crystallites.

In a particularly preferred embodiment, the primary crystallites of the zeolite are at least partly agglomerated to form agglomerates. It is advantageous for a proportion of at least 30%, preferably at least 60%, in particular at least 90%, of the primary crystallites to be agglomerated to form agglomerates. The percentages are based on the total number of primary crystallites.

When the above-described conditions are adhered to in the synthesis of the zeolite of the ZSM-12 type, a particularly advantageous morphology of the agglomerates of the very small primary crystallites which also has a positive influence of the catalytic activity of the ZSM-12 zeolites is obtained. The agglomerates have a large number of voids or intestices between the individual primary crystallites on their surface. The agglomerates thus form a loose composite of primary crystallites having voids or intestices between the primary crystallites which can be accessed from the agglomerate surface. On scanning electron micrographs, the agglomerates appear as sponge-like structures having a strongly fissured surface produced by the loose cohesion of the primary crystallites. The micrographs preferably display relatively large spherical agglomerates which have a broccoli-like form. The structured surface is made up of primary crystallites which form a loose composite. Between the individual crystallites, there are voids from which channels lead to the surface and which appear as dark ridges of the surface in the micrographs. Overall, a porous structure is obtained. The agglomerates formed by the primary crystallites are preferably in turn joined to form larger higher-order agglomerates between which individual channels having a larger diameter are formed.

For use as catalyst, in particular when used for hydrogenations, dehydrogenations and hydroisomerizations, the catalyst is additionally provided with suitable activating compounds (active components). The addition of the active components can be effected by any method with which those skilled in the art are familiar, e.g. by intensive mixing, vapor deposition, steeping in or impregnation with a solution or incorporation into the zeolite. The zeolite obtained is preferably provided with at least one transition metal, particularly preferably at least one noble metal. For this purpose, the zeolite is, for example, impregnated with an appropriate solution of the transition metal or a noble metal. Loading with platinum can be carried out using, for example, an aqueous H₂PtCl₆ solution. The impregnation solution is preferably used in such an amount that the impregnation solution is completely absorbed by the catalyst. The catalysts are subsequently dried, for example at temperatures of from about 110 to about 130° C. for from 12 to 20 hours, and calcined, for example at from 400 to 500° C. for from 3 to 7 hours. The catalysts produced in this way are particularly suitable for modification of hydrocarbons. They are suitable, for example, for the reforming of fractions from petroleum distillation, for increasing the flowability of gas oils, for the isomerization of olefins or aromatic compounds, for catalytic or hydrogenated cracking and also for the oligomerization or polymerization of olefinic or acetylenic hydrocarbons. Further applications are alkylation reactions, transalkylation, isomerization or disproportionation of aromatics and alkyl-substituted aromatics, dehydrogenation and hydrogenation, hydration and dehydration, alkylation and isomerization of olefins, desulfonation, conversion of alcohols and ethers into hydrocarbons and conversion of paraffins or olefins into aromatics.

The invention is illustrated below with the aid of examples and with reference to an accompanying FIGURE. Here:

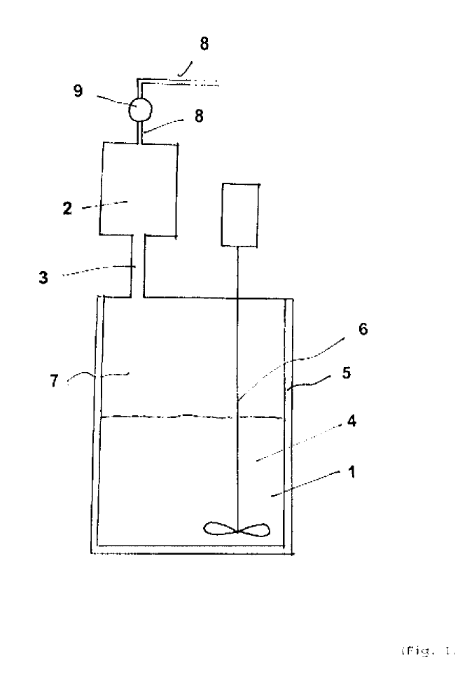

FIG. 1 schematically shows a section through a reaction vessel according to the invention.

FIG. 1 shows, very schematically, a longitudinal section through a reaction vessel according to the invention. The reaction vessel comprises two different tanks, a main tank 1 and a turbulence-reduction tank 2. Main tank 1 and turbulence-reduction tank 2 are connected via line 3. The main tank 1 has a significantly lager volume than the turbulence-reduction tank 2. The cross section of the line 3 is in turn made considerably smaller than the cross section of the turbulence-reduction tank 2. The reaction mixture 4 is introduced into the main tank 1 and the main tank is heated by means of a heating jacket 5 until the desired reaction temperature, for example 165° C., has been attained in the reaction mixture 4. The reaction mixture 4 can be agitated by means of a stirrer 6. The reaction mixture 4 comprises, for example, a synthesis gel for the synthesis of a molecular sieve, in particular for the synthesis of a zeolite, which gel has been produced from a predominantly aqueous suspension which contains, for example, an aluminum source, a silicon source, organic template, for example a tetraalkylammonium salt as template, and, if appropriate, alkali metal and/or alkaline earth metal sources. As a result of the heating of the reaction mixture, the pressure in the main tank 1 and thus also in the line 3 and the turbulence-reduction tank 2 rises. Tn addition, components of the reaction mixture 4 go over into the gas phase 7 present above the reaction mixture 4, for example water vapor. During the synthesis of the molecular sieve, part of the organic template, for example of the tetraalkylammonium salt used, decomposes with elimination of gaseous by-products. These likewise go over into the gas phase 7 and result in an additional pressure increase in the reaction vessel. The components present in the gas phase go via line 3 into the turbulence-reduction tank 2. Heat can be removed via the exterior walls of the turbulence-reduction tank 2, so that vaporized constituents of the reaction mixture 4, for example water vapor, condense again and flow back into the main tank 1 via the line 3. The cross section of the line 3 is selected so that the liquid phase condensed in the turbulence-reduction tank 2 can flow back into the main tank 2 without being forced back by the ascending gases which flow from the main tank 1 into the turbulence-reduction tank 2. The gaseous by-products formed from the tetraalkylammonium salt collect in the turbulence-reduction tank 2 as a result of the condensation of the components of the reaction mixture 4. A discharge line 8 leads from the turbulence-reduction tank 2 to a pressure-regulating valve 9. The pressure-regulating valve 9 is set to a particular counterpressure. When the pressure in the reaction vessel increases due to the evolution of gaseous by-products, it exceeds this counterpressure exerted by the pressure-regulating valve so that the latter is opened. The gaseous by-products can then be discharged via the discharge line 8 and passed to a work-up. As a result of the outflow of the gaseous by-products, the pressure in the reaction vessel drops, so that the pressure falls below the pressure set in the pressure-regulating valve 9. The pressure-regulating valve 9 closes again as a result. In this way, the pressure prevailing in the reaction vessel, i.e. in the reaction system formed by the main tank 1, the line 3 and the turbulence-reduction tank 2, can be kept approximately constant. The pressure resistance of the main tank 1, the turbulence-reduction tank 2 and the line 3 can therefore be designed accordingly.

### EXAMPLE

### Synthesis of ZSM-12

To produce the ZSM-12 zeolite, a synthesis gel composition having the following composition:

8.5952 H₂0 : SiO₂: 0.0099 Al₂0₃: 0.0201 Na₂O: 0.1500 TEAOH.

### TEAOH=tetraethylammonium hydroxide, was prepared.

271.2 g of sodium aluminate and 99.1 g of NaOH were dissolved in 9498.3 g of an aqueous solution of tetraethylammonium hydroxide (35% by weight) and 15 905.3 g of water while stirring. The solution was placed in a 40 liter capacity pressure vessel which was provided with a stirrer. A turbulence-reduction tank having a volume of 300 ml was connected to the pressure vessel via a line which had an internal diameter of 5 mm. The turbulence-reduction chamber was equipped with an adjustable spring valve via which gas could be discharged from the turbulence-reduction tank into the surroundings. While stirring vigorously, 10 227.1 g of precipitated silica having a specific surface area of 170 m²/g was added in small portions. A highly viscous gel which had a pH of 13.7 at 24.0° C. was obtained. The pressure vessel was closed and the contents were heated at 163° C. for 12 hours and then maintained at this temperature for a total reaction time of 155 hours. The pressure-regulating valve was set during this time to a counterpressure of 12 bar. During the reaction time, the pressure-regulating valve opened at intervals so that gas phase was discharged from the reaction system.

After 155 hours had elapsed, the pressure vessel was cooled to room temperature. The solid product was separated from the mother liquor by filtration and subsequently washed with demineralized water until the conductivity of the washings was below 100 μs/cm. The filtercake was dried at 120° C. in the presence of air for 16 hours and subsequently calcined in the presence of air. In the calcination, the dried solid was firstly heated to 120° C. at a heating rate of 1 K/min and maintained at this temperature for 3 hours. It was subsequently heated to 550° C. at a heating rate of 1 K/min and this temperature was maintained for 5 hours.

Examination by X-ray diffraction indicated that ZSM-12 had been formed. Examination by scanning electron microscopy shows agglomerates which have a diameter of about 0.8 μm and are made up of small primary crystallites. The agglomerates display a broccoli-like structure.

### LIST OF REFERENCE NUMERALS

1. Main tank
2. Turbulence-reduction tank
3. Line
4. Reaction mixture
5. Heating jacket
6. Stirrer
7. Gas phase
8. Discharge line
9. Pressure-regulating valve

1. (canceled)

2. (canceled)

3. (canceled)

4. (canceled)

5. (canceled)

6. (canceled)

7. (Canceled)

8. (canceled)

9. (canceled)

10. (canceled)

11. A process for producing a molecular sieve, wherein:
a synthesis gel in a predominantly aqueous solution is produced comprising:
a) at least one starting material selected from the group consisting of an aluminum source, a silicon source, a titanium source, a gallium source, a chromium source, a boron source, an iron source, a germanium source and a phosphorus source; and
b) an organic template;
wherein the synthesis gel is crystallized under essentially isobaric conditions in a reaction vessel,
the solid is separated off, and
the solid is, washed and dried,
wherein the reaction vessel comprises
a pressure-resistant main tank;
a turbulence-reduction tank which is connected to the main tank and is located above the main tank, with the main tank and the turbulence-reduction tank connected via an essentially vertical line whose cross section is selected so that condensate can flow back from the turbulence-reduction tank into the main tank without backpressure; and
wherein the turbulence-reduction tank has a pressure-regulating valve through which gaseous products can be discharged from the turbulence-reduction tank to the outside.

12. The process as claimed in claim 11, further comprising removing gaseous by-products from the reaction vessel during the reaction.

13. The process as claimed in claim 11, wherein the reaction is carried out at a pressure of more than 8 bar.

14. The process as claimed in claim 11, wherein the reaction vessel is heated to set the pressure.

15. The process as claimed in claim 11, wherein the molecular sieve comprises a zeolite and the synthesis gel comprises at least one aluminum source and a silicon source as starting material, with the molar ratio of H₂0:SiO₂ in the range from 5 to 15.

16. The process as claimed in claim 11, wherein the organic template comprises a quaternary ammonium salt.

17. The process as claimed in claim 15, wherein the synthesis gel further comprises an alkali metal and/or alkaline earth metal ion source M having a valence n, and wherein the molar ratio of M_{2/n}O:SiO₂ in the synthesis gel composition is set in the range from 0.01 to 0.045.

18. The process as claimed in claim 15, wherein the molar ratio of SiO₂/Al₂0₃ is set in the range from 50 to 150.

19. The process as claimed in claim 11, wherein the crystallization of the synthesis gel is carried out at temperatures from 120° C. to 200° C.

20. The process as claimed in claim 11, wherein the crystallization time is from about 50 to 500 hours.

21. The process as claimed in claim 16, wherein the quaternary ammonium salt comprises a tetraethylammonium salt.

22. The process as claimed in claim 11, wherein the pressure-regulating valve comprises a spring valve.

23. The process as claimed in claim 11, wherein the turbulence-reduction tank has a volume which corresponds to from 0.5% to 5% of the volume of the main tank.

24. The process as claimed in claim 11, wherein a cross section of the vertical line is less than 10% of the cross section of the turbulence-reduction tank.

25. The process as claimed in claim 11, wherein the turbulence-reduction tank is provided with air cooling.

26. The process as claimed in claim 11, wherein the ratio of height to width of the turbulence-reduction tank is in the range from 3/1 to 1/5.

27. The process as claimed in claim 11, wherein the main tank and the turbulence-reduction tank have a pressure resistance of at least 10 bar.

28. The process as claimed in claim 11, wherein the pressure-regulating valve has a range of fluctuation of less than 2 bar.
